(19) United States
(12) Patent Application Publication
(10) Pub. No.: US 2005/0165628 A1
(43) Pub. Date: Jul. 28, 2005

(54) Method and system for rescheduling passengers

(75) Inventors: Bo Valdemar Vaaben, Espergaerde (DK); Serguei Romualdovich Tiourine, Gothenburg (SE); Niklas Kohl, Tarnby (DK); Antonio Pedro Almeida Viegas Alves, Porto (PT)

Correspondence Address: George N. Chaclas;Edwards & Angell, LLP, P. O. Box 55874, Boston, MA, 02205, US

(73) Assignee: Carmen Systems AB

(21) Appl. No.: 10/765,605

(22) Filed: Jan. 27, 2004

(51) Int. Cl. G06F 17/60

(52) U.S. Cl. 705/5; 705/1; 705/13

(57) ABSTRACT

A method of generating solutions for rescheduling objects such as passengers and cargo. The objects are grouped into subproblems according to segments. Initial solutions are generated without varying the origin and destination for any of the objects. Upon creating the initial solutions, objects that are unsuitably rescheduled are grouped together and rescheduled without constraint to reduce the scope of the original rescheduling problem. The reduced problem is then reevaluated for further improvement.

### RELATED APPLICATION

This application is related to U.S. patent application Ser. No. 10/631,600 filed Jul. 31, 2003, which is incorporated herein by reference in its entirety.

### BACKGROUND OF THE INVENTION

1. Field of the Invention

The subject disclosure relates to methods and systems for scheduling and rescheduling passenger itineraries, and more particularly to an improved method and system for re-accommodating passengers after a disruption in operation.

2. Background of the Related Art

Most commercial airlines have stated their main goal is to focus on passenger satisfaction. A myriad of factors determine passenger happiness such as positive interaction with employees, cleanliness of the airplane cabins, competitive pricing, timeliness of the airline's flights and the like. One of the most significant factors related to passenger satisfaction is the airline's ability to re-accommodate passengers when a disruption occurs. In order to accomplish the very complicated rebooking problems that are presented by disruptions, airlines commonly utilize sophisticated optimization software applications. Prior art optimization suites of software propose possible solutions that require evaluation and selection by the airline.

Not only airlines but other businesses in many areas benefit from optimization software to adjust and maintain complicated schedules to accomplish activities. For example, railways, buses, production lines, retailers, supply chains and logistics, and hospitals all have various resources including vehicles, machinery, floor space, staff and customers that must be coordinated on a grand scale. These schedules are subject to change based upon circumstances beyond the businesses control. When such disruptions occur, operations managers are typically unable to quickly and efficiently reschedule continuing operations without aid. The prior art systems aid in decision making and are widely used and well understood by those of ordinary skill in the pertinent art. Some examples are illustrated in U.S. Pat. No. 6,314,361, European Patent App. No. 1,195,670 and PCT Patent App. No. WO 02/097570 which are incorporated herein by reference.

There are problems associated with the systems and methods of the prior art. Many algorithms are well known that apply operations to produce every combination in the neighborhood and pick the cheapest solution. However, this brute force approach may take unduly long as the size of the neighborhood may require execution of a large number of operations. This approach fails to recognize that often a small “optimality gap” is acceptable to expedite selecting a solution. The “optimality gap” is the difference between a low cost solution that may be found quickly and an optimal solution that may take tremendous effort to find. Thus, what is needed is a method for quickly generating adequate solutions to large scale problems.

Moreover, prior art systems are designed to find a solution for a very large scale problem resulting from a major disruption. As a result, such systems and methodology often take unacceptably long intervals to develop solutions which remain suboptimal even if the scope of the problem is small. There is a need, therefore, for an improved system and method which approaches optimally solving disruptions with a focus on the details specific to the typical day to day minor disruptions and, yet is scalable to assist in very large scale disruptions.

Additionally, operations may involve multiple coordinated resources. For example, in the airline industry, operations managers often have to re-accommodate delayed passengers as well as significant rescheduling of airline crews and airplanes. Heretofore, an optimization aid used for one resource has been unable to interact with other optimization aids for the related resources. Moreover, one optimization aid has been unable to provide suggestions for re-timing flights in order to yield an overall improved solution. As a result, significant resources and valuable time are consumed pursuing rescheduling that is acceptable for utilizing one resource but completely unacceptable when the total impact is considered.

For example, U.S. Pat. No. 6,314,361 to Yu et al. shows an optimization server 1 that processes a request from a user for optimal solutions to a specific flight schedule disruption. In response to the request, the optimization server 1 initiates an aircraft optimization engine 3. The aircraft optimization engine 3 processes the request and generates a set of solutions to overcome the disruption. In turn, the aircraft optimization engine 3 initializes a crew optimization engine 5 to determine whether the set of flight solutions are efficiently supported by flight and service crews. Many of the solutions or options produced by the optimization engine 3, although reasonably optimized in consideration of aircraft utilization, turn out to be wholly unacceptable options when viewed in light of the ramifications upon crew and passenger inconvenience. Thus, critical resources and time are utilized to produce and evaluate solutions which are unacceptable and must be discarded. Accordingly, what is also needed is an integrated operations framework which allows information to be exchanged among different resource optimization engines prior to generating solutions to yield an overall optimum solution without expending critical resources on solutions directed to a portion of the solution without considering the whole.

### SUMMARY OF THE INVENTION

The present invention is directed to a method for generating a solution to a problem having objects scheduled originally in itineraries, each original itinerary having at least an origin and a destination, the method including the step of receiving a disruption specification based upon an event. The disruption specification includes data identifying the objects to be rescheduled. The method also includes the steps of receiving a request for rescheduling of the objects from a user, grouping the objects to be rescheduled into subproblems, wherein each subproblem is defined by each object therein having the same original origin and destination. A first algorithm is applied to each subproblem without allowing varying the origin and destination of the objects in the subproblem for simplification and, in turn, quickly reaching initial solutions. A subclass of objects are identified as unsuitably rescheduled in the initial solutions and a second algorithm is applied to reschedule the subclass by varying the original itinerary to generate rescheduling solutions for the subclass. The method further includes the steps of excluding the subclass of objects from the objects that need to be rescheduled in the disruption specification and applying a third algorithm to the remaining objects in the reduced disruption specification to determine rescheduling solutions for the remaining objects.

In another embodiment, a method generates solutions to problems having objects scheduled in itineraries. The method includes the steps of receiving a disruption specification based upon an event, wherein the disruption specification including data identifying objects to be rerouted. The objects are grouped into subproblems, wherein each subproblem is defined by each object therein having the same original origin and destination, and an algorithm generates solutions to each subproblem.

It is an object of the disclosure to produce solutions for re-accommodating passengers in response to major and minor disruptions as quickly as possible with as little change as possible while minimizing airline policy violations. It is another object of the disclosure to manage perception of disruptions by passengers while minimizing monetary and other costs.

It is another object of the disclosure to provide the ability to assign top priority to customer satisfaction over maximum utilization of airline fleets and crews in response to disruptions.

It is still another object of the invention to minimize passenger delay not only along their next leg but to their final destination. It is another object of the invention to facilitate assigning priority to high value passengers.

In another embodiment, a method generates solutions to problems having objects scheduled in itineraries. The method includes the steps of receiving a disruption specification based upon an event, wherein the disruption specification including data identifying at least one object to be rerouted. A shortest path algorithm generates a plurality of possible rerouting itineraries for at least one object. An IP problem is formed from the possible rerouting itineraries and an IP algorithm solves the IP problem to generate a practical solution for rerouting the at least one object.

It is still another object of the invention to provide a quick overview of the passengers affected by a disruption to allow focusing resources more approproately on the most severely disrupted passengers.

It is still another object to recognize and control the consequences of different recovery solutions with an effective means for comparing solutions.

It should be appreciated that the present disclosure can be implemented in numerous ways, including without limitation as a process, an apparatus, a system, a device, a method, or a computer readable medium for applications now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings wherein:

FIG. 1 an overview of an environment in which an embodiment of the present invention may be used.

FIG. 2 is a flowchart illustrating a problem solving cycle in accordance with the subject disclosure.

FIGS. 3A-B are flowcharts illustrating in detail three different methods, respectively, for generating solutions in accordance with the subject disclosure.

FIG. 4 is a somewhat schematic representation of two subproblems formed during generation of solutions.

FIG. 5 is a somewhat schematic representation of a rescheduling solution for one of the subproblems of FIG. 4.

FIG. 6 is a screenshot showing an exemplary summary produced by a passenger solver in accordance with the subject disclosure.

FIG. 7 is an additional portion of the screenshot of FIG. 6.

### DETAILED DESCRIPTION OF PREFERRED EMBODIMENTS

The present invention overcomes many of the prior art problems associated with optimization engines. The advantages, and other features of the system and method disclosed herein, will become more readily apparent to those having ordinary skill in the art from the following detailed description of certain preferred embodiments taken in conjunction with the drawings which set forth representative embodiments of the present invention.

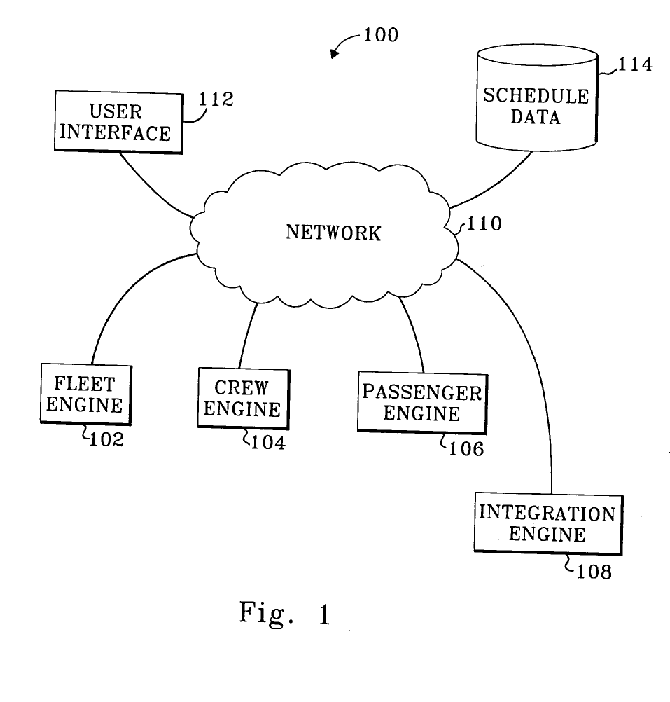

Referring to FIG. 1, there is illustrated a schematic representation of an environment 100 in which the system and method of the present invention may be implemented. The exemplary environment 100 relates to the airline industry and, for simplicity, the following description relates to one airline operating the environment 100. It will be appreciated by those of ordinary skill in the pertinent art that many diverse industries would be able to advantageously apply and utilize the inventive concepts disclosed herein.

The environment 100 includes a fleet engine 102, a crew engine 104, a passenger engine 106 and an integration engine 108 which communicate with a distributed computer network 110 via two-way communication channels. Note that the two-way communication channels are representative of a number of different communication channels known in the art, whether wired or wireless, such as telephone lines, optical cables, radio frequency, satellite and other means of transmission now known and later developed. When a disruption occurs, the subject system and method will produce a plurality of solutions for evaluation by the controller or operations manager.

Each engine 102, 104, 106 stores a set of parameters related to resource utilization with associated costs. The costs are actual monetary costs and user selectable penalty value costs that reflect the user's business policies and objectives. For example, delays affect passengers can be munerically represented with a passenger value delay minute (“PVDM”), allowing quantitative comparison of an otherwise subjective factor. Each engine 102, 104, 106 also contains feasibilty and legality information related to utilization of the resources. The integration engine 108 exchanges data between other engines 102, 104, 106 to yield integrated solutions.

It is envisioned that each of the engines 102, 104, 106, 108 may incorporate one or more servers. Multiple servers can cooperate to facilitate greater performance and stability of the subject invention by distributing memory and processing as is well known. In another embodiment, the environment 100 will also include Disruption Manager servers [not shown] that are specific to particular operational areas. For example, an operations manager will be connected to a Fleet Disruption Manager server that provides access to relevant information and resources such as fleet engine data, operational alerts from the fleet engine and the like. In a preferred embodiment, the environment 100 includes a Disruption Manager server for each engine 102, 104, 106, 108.

Distributed computer network 110 may include any number of network systems well known to those skilled in the art. For example, distributed computer network 110 may be a combination of local area networks (LAN), wide area networks (WAN), intranets or the Internet. The distributed computer network 110 not only allows the components of the environment 100 to communicate but components may be added and upgraded as desired. For example, a hub recovery engine [not shown] may be added to the environment 100 and utilized in an embodiment of the subject disclosure as would be appreciated by those of ordinary skill in the art. The design of the interface of the distributed computer network 110 places minimal requirements on components for facilitating integration. For example, the components may only need send and receive messages in a format which can be utilized by the other components. In a preferred embodiment, the distributed computer network 110 only requires that the components read and write Extended Mark-up Language (“XML”) messages from an asynchronous queue.

A user interface 112 is connected to the network 110 for providing the operations manager with access to the engines 102, 104, 106, 108. When a disruption to the schedule occurs, the operations manager will provide the particulars of the disruption in a request for a solution to the engines 102, 104, 106, 108 via the interface 112. The particulars of the disruption are referred to as the “disruption specification”. In a prefered embodiment, the operations manager can select a planning horizon within the disruption specification. The planning horizon is the period of time into the future that the solutions must consider. Thus, feasibility and legality are also considered within the planning horizon time frame. The part of the schedule that lies beyond the planning horizon is not checked for feasibility or legality. In a preferred mode, the default planning horizon is set as midnight on the current day of operation. Therefore, all schedule activities that begin within the planning horizon are verified for feasibility and legality. The user interface 112 is designed to work in a multi user environment. A user can log in to the environment 100 and receive a certain access level. For example, view only access will allow to the user to see the current state of the schedule and operational alerts, but not to modify such data.

Upon receipt of the request for solution with disruption specification, the engines 102, 104, 106, 108 begin the process of providing a rescheduling solution. The engines 102, 104, 106, 108 acquire the most recent schedule data from a memory storage system 114 and perform operations to generate a rescheduling solution as described in more detail hereinbelow. The memory storage system 114 is connected to the distributed computer network 110 by a two-way communication channel. Preferably, the data within the memory storage system 114 is maintained automatically. In order to allow a hot start of the engines 102, 104, 106, 108, the data within the memory storage system 114 is periodically downloaded to the engines 102, 104, 106, 108. Thus, when a request is received, the data synchronization merely involves the changes since the last refresh and, thereby, the data acquisition time is minimized. In a preferred embodiment, the data within the memory storage system 114 is downloaded to the engines 102, 104, 106, 108 every two minutes.

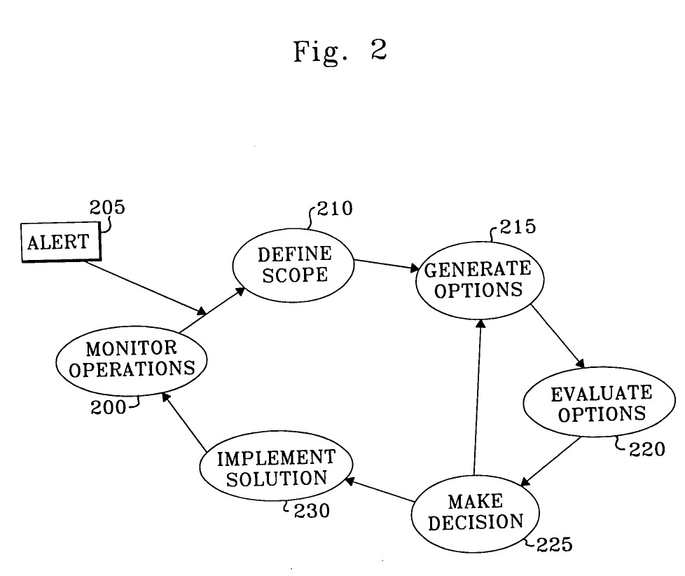

Referring now to FIG. 2, a graphical representation of the problem solving cycle is shown. When no disruptions are present, the operations manager monitors operations at step 200. During normal operations, preprocessing occurs. For example, the passenger engine 106 generates flight value properties based upon the details about the passengers currently booked on each flight. The flight value property is an indication of the importance of the flight to the airline. The flight value properties for each flight are provided to the fleet engine 102 and crew engine 104. Based upon the flight value properties, the fleet engine 102 and crew engine 104 can avoid delays, cancellations and downgrades of the flights with the highest flight value property. The flight value property may be represented in dollars or abstract units. In a preferred embodiment, the flight value properties are recalculated every 10 minutes to reflect changes in passenger bookings.

Preferably, the major preprocessing in the environment 100 is performed during off peak hours such as during the night with smaller preprocessing tasks being done hourly. The operations manager can also manually trigger preprocessing. In short, a goal of preprocessing is to perform a so-called sensitivity analysis, i.e. to inhibit the inherent flexibility in the schedule. The results of the preprocessing are used for processing disruption requests. Additional preprocessing is preferably not performed after receipt of a disruption request mainly due to time constraints. Such initial information of additional constraints provides for efficient use of resources in generating solutions.

When a disruption occurs, data relating to the disruption is entered via user interface 112 and an alert is generated as denoted by action box 205. The cycle proceeds to define the scope of the disruption at step 210. Defining the scope of the disruption includes determining the time frame, severity and resources affected by the disruption to generate a disruption specification. In a preferred embodiment, the integration engine 108 receives the data relating to the disruption, accesses the schedule data in the memory storage system 114 and creates the disruption specification. Typically, the disruption specification includes at least the affected flights and whether the flights are delayed or cancelled.

The overall feasibility, legality and quality issues are controlled using the integration engine 108. In one embodiment, the integration engine 108 includes a submodule for storing and processing rules. Rules are resource specific and preferably encapsulated within each engine, 102, 104, 106, 108. The rules may be hard rules that cannot be violated or soft rules that can be violated by assumption of a corresponding penalty. The rules in the integration engine 108 are all soft such that overall best solutions are acquired by adjusting soft costs and parameters of the other engines 102. 104, 106. By reviewing hard and soft rules for violations in the engines 102, 104, 106, the solutions that violate feasibility, legality and quality policies can be discarded prior to being provided to the operations manager for review.

In another embodiment, the integration engine 108 filters, discards and rates the solutions prior to presentation to the operations manager. Similarly, the other engines 102, 104, 106 may utilize submodules for storing data and rules specific to the associated resource. In a preferred embodiment, the operations manager can introduce changes to the rules parameters within the rules submodules at short notice. By allowing changes to the rules submodules, changes to crew agreements, timetables, company policies, planning processes and the like can always be properly reflected in the solutions. Rules for aircraft are typically determined by the aircraft manufacturers with little, if any, variance therebetween so it is envisioned that changes would be infrequent. Example of hard rules are runway lengths, aircraft operating range, fuel capacity, number of seats available and the like whereas soft rules are maintenance intervals, turnaround time, curfews and the like.

At step 215, the integration engine 108 provides the disruption specification to each engine 102, 104, 106. Each engine 102, 104, 106 performs initial processing based upon the schedule data 114. The initial information is provided to the integration engine 108 for access by the other engines. Typical initial information would be penalty value costs associated with actions related to recovering from the disruption. For another example, the fleet engine 102 generates initial information related to available standby aircraft, cancellation penalties, and preferred latest departure time for an aircraft affected by the disruption. The crew engine 104 generates initial information related to tight connection constraints for crews, cancellation penalty value cost and crew limitations such as latest departure times, also called crew drop-dead limit. The passenger engine 106 generates initial information related to flight values, passengers per class, connection constraints for passengers, cancellation penalty value costs and PVDM. The passenger engine 106 may request a fleet upgrade to a larger aircraft on a particular leg to accommodate disrupted passengers. Preferably, the initial information does not include the details required to generate the feasibility, legality and cost (both real and penalty value) data. For example, detailed passenger information such as passenger name records is required by the passenger engine 106 during the preprocessing however the fleet engine 102 and crew engine 104 do not require such detailed passenger information.

After the initial processing, the integration engine 108 may choose one or more engines 102, 104, 106 to generate solutions in view of the initial information. In a preferred embodiment, the disruption specification is sent to the fleet engine 102 and the crew engine 104 for generating a number of solutions. The recovery solutions are then attached to the disruption specification that is sent to the passenger engine 106. The passenger engine 106 can then provide an overall recovery solution or a plurality of ranked recovery solutions.

As the selected engine or engines generate solutions, some solutions can be immediately discarded in view of feasibility, legality and excessive penalty problems identified by the other engines during preprocessing. Hence, the small amount of time spent preprocessing is more than saved by quickly discarding unacceptable solutions in view of initial information generated by the engines 102, 104, 106. In short, even though the solution may be acceptable when viewed in the limited scope of one area of resources, the subject system and method quickly discards some of these solutions if the solution is undesirable when the overall impact is considered.

In another embodiment, the integration engine 108 evaluates the disruption specification and identifies only one engine to generate solutions. In one embodiment, the engine initially chosen may attempt to create a solution or solutions to the disruption without impacting other resources or schedules. Thus, evaluation of the solutions by the other engines will only take into account limited actions. If the solutions must impact the other resources or schedules, the solutions are evaluated by the corresponding engines for feasibility, legality and penalty value cost at step 220. In still another embodiment, the integration engine 108 provides the disruption specification to one or more of the engines 102, 104, 106 for each to generate solutions in parallel with or without preprocessing as desired.

Still referring to step 215 of FIG. 2, the preferred method efficiently produces one or more solutions. For simplicity, the following disclosure is with respect to a single engine, the passenger engine 106, generating solutions but it will be appreciated by those of ordinary skill in the art that the principles may be advantageously used with the other engines 102 and 104 and in other industries such as for railroads, cargo, hospitals, retailers and any industry with sophisticated schedules that may need revising. The passenger engine 106 schedules passengers on aircraft to complete flights called “legs”. An itinerary is the combination of legs that a passenger takes from their origin to their destination. The passenger engine 106 uses a variety of operations to create a set or neighborhood of possible rescheduled passenger itineraries. Typical recovery operations for the passenger engine 106 are upgrades, downgrades, offloading, and switching to a different leg. Each recovery operation may incur real monetary costs and more penalty-like costs, where the purpose of the latter is to reflect the inconvenience of the operation to the passenger or the airline. Both types of costs are user-specifiable.

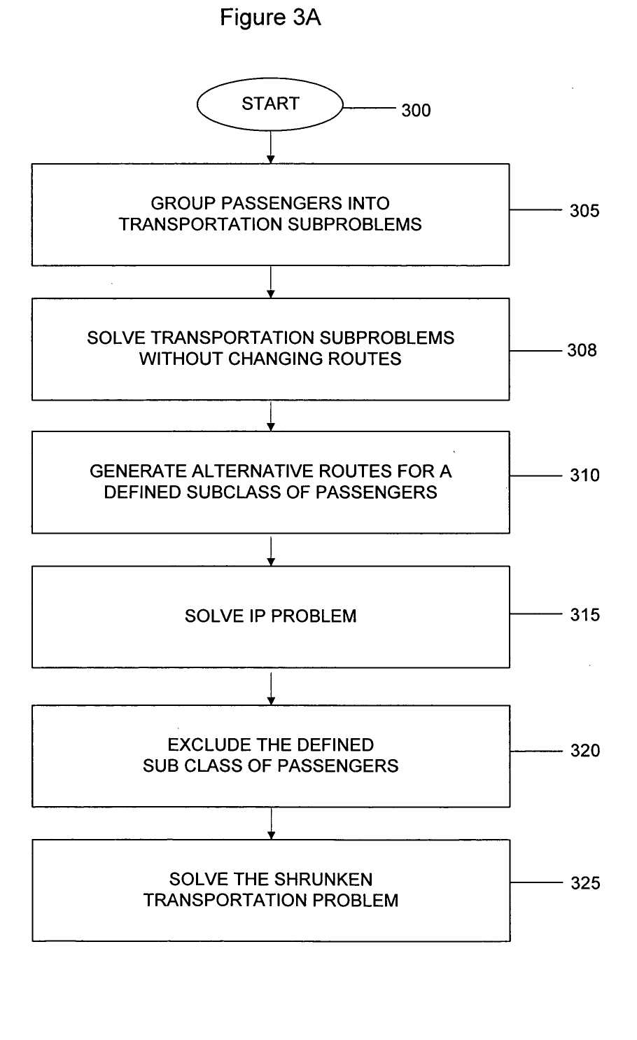

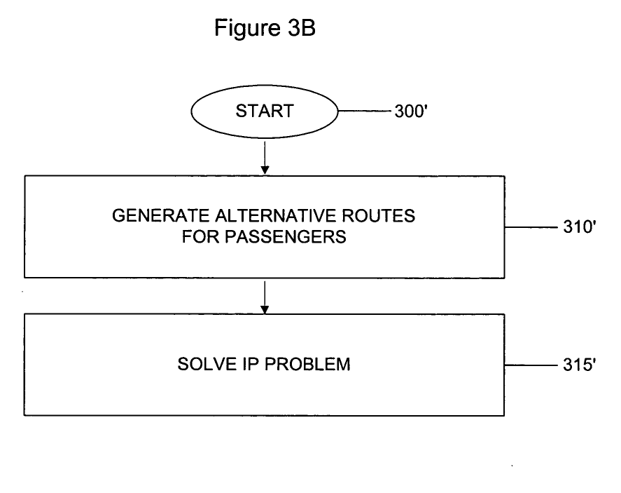

Referring now to FIG. 3A, a method of the passenger engine 106 for generating different alternative solutions is described in more detail. At step 300, the passenger engine 106 has the disruption specification and up-to-date schedule data from the memory storage system 114 and the generation of solutions begins. The disruption specification would typically include the affected flights and passengers.

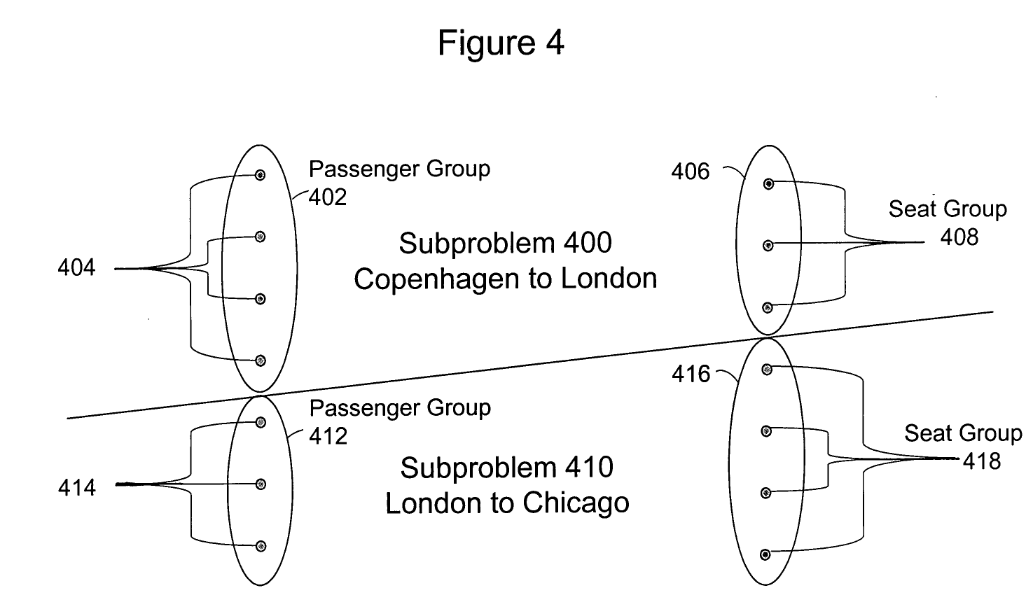

At step 305, the passenger engine 106 decomposes the rescheduling problem by creating subproblems by segments. Referring now to FIG. 4, a subproblem 400 includes the set of all passengers 402 that are displaced from the same segment. In the example shown, the leg of the subproblem 400 is a Copenhagen to London itinerary. Within the set of passengers 402, some passengers may have been scheduled to travel first class, business class, tourist class or on different flights as denoted by groups 404 within the set of passengers 402. The subproblem 400 also includes the set of seats 406 available seats for transporting passengers along the segment. Within the set of seats 406, some seats are in different classes and on different flights as denoted by groups 408.

Still referring to FIG. 4, another subproblem 410 includes a second set of passengers 412 and available seats 416. The subproblem 410 is related to subproblem 400 in that one or more passengers may be traveling along both legs. For example, the leg of the subproblem 410 is a London to Chicago itinerary that may be traveled by passengers within the set of passengers 402. In subproblem 410, some passengers may have been scheduled to travel in different classes or on different flights as denoted by groups 414 within the set of passengers 412. The set of seats 416 may be in different classes and on different flights as denoted by groups 418.

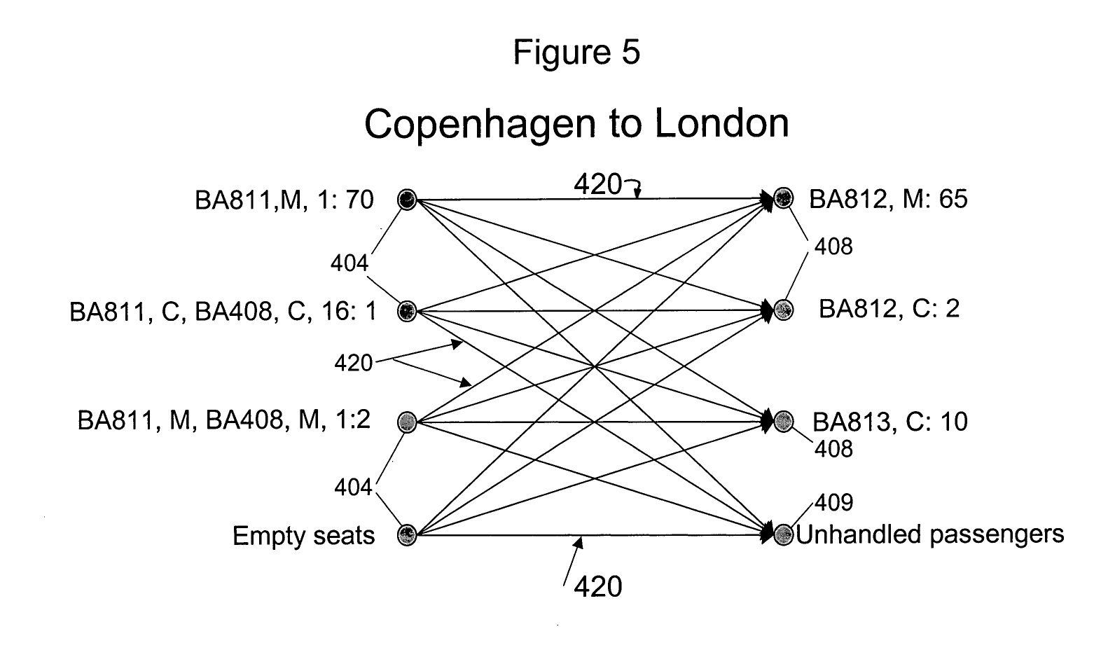

Referring now to FIG. 5, the groups 404 of passengers include associated information. For example, a group of seventy passengers may have originally been scheduled on flight BA811 in class M with a passenger value of one. For another example, a single passenger may have originally been scheduled on flight BA811 in class C, arriving on flight BA408 in class C with a passenger value of sixteen.

The passenger groups can be referred to as producers, which are producing commodities (in this case passengers) that are utilized by consumers. In this instance, the consumers would be the seats 408 on various flights in associated classes. For example, passengers 404 may be rebooked in sixty-five seats on flight BA812 in class M. The producers and consumers are connected by arcs that are represented by arrows 420. In this instance, the number of passengers 404 should equal the number of passengers reassigned into seats 408. In certain circumstances, some passengers 404 may be unhandled as indicated by group 409. By assigning a very high cost to not handling passengers, this possibility will only be used when there are no other alternatives for transporting the passenger on this segment.

The cost of each arc or reassignment is a value that can be determined by the passenger engine 106 or in a separate module for determining costs such as RAVE™ available from the assignee of this invention. By grouping the passenger according to commonalities, the computational effort required from the separate module for determining costs is reduced. In one embodiment, the factors that determine the cost of each arc are the value of the passenger, passenger upgrades and downgrades, PVDM, and passenger compensation costs such as food vouchers, travel vouchers, hotel accommodations and cash payments to passengers and the like.

Referring again to FIG. 3A, at step 308, a first algorithm is applied to find an optimal solution for each group of passengers in a limited manner. The first algorithm is limited in that the solution is constrained by maintaining each passenger on their original itinerary. In one embodiment, the first algorithm is well suited to solve a transportation problem that is a type of linear programming (hereinafter “LP”) problem. The term transportation problem is commonly used among those of ordinary skill in the pertinent art because of the many applications involving how to optimally transport goods. In a typical disruption scenario, merely applying a Simplex algorithm without exploiting the special characteristics of the problem would require an unreasonably large computational effort because of the large number of variables.

In a preferred embodiment, the decomposition of the disruption specification into segments yields a transportation problem that has zero for most coefficients in the LP matrix and the relatively few non-zeroes appear in a distinct pattern. As a result, application of a streamlined Simplex algorithm achieves dramatic computational savings by exploiting the special structure of the problem. This first algorithm is also referred to as the “Transportation Simplex Method”.

In summary, at steps 305 and 308, the disruption specification is decomposed into a number of smaller problems of how to transport each passenger along their original itinerary, e.g., a plurality of transportation subproblems. The decomposition into subproblems based upon segments allows application of the first algorithm to quickly solve each subproblem. In the preferred embodiment, the first algorithm is limited to considering only the decomposed parts or subproblems without changing the routes. Consequently, small disruptions and problems for airlines with a single hub can advantageously be solved with by applying steps 305 and 308. However for larger problems, the solutions produced by the first algorithm at step 308 may not be optimal because some passengers could be more efficiently carried along alternate routes that were not considered. For example, rather than letting a passenger suffer an extraordinarily long delay, improved results can be achieved by rerouting the passenger via an alternative airport. The reality of being able to more quickly carry the passenger to their destination by traveling along an alternative route is not considered at steps 305 and 308. Consequently, further solving of the disruption specification can be advantageous.

Accordingly, the passenger engine 106 proceeds to step 310 where the passenger engine 106 determines if a defined subclass of passengers can be rescheduled more efficiently. A second algorithm generates alternative itineraries for the defined subclass of passengers without being constrained to maintaining each passenger along their original itinerary. The second algorithm generates a plurality of rerouting scenarios for each passenger in the defined subclass. Preferably, the second algorithm is a shortest path algorithm such as Dijkstra's algorithm, a K-shortest path algorithm and the like. The subclass of passengers includes one or more criteria as defined by the operations manager in accordance with the airline policy. Exemplary criteria are the most severely affected passengers, highly valued passengers, children traveling alone and handicapped passengers. In one embodiment, a cost representative of the passenger's changed itinerary is compared to a predefined threshold wherein any passenger that has a cost above the threshold is evaluated for rerouting.

At step 310, the passenger engine 106 creates a network from the defined subclass of passengers. The network consists of a series of nodes interconnected by arcs. The nodes are tuples of an airport and a passenger arrival time at the corresponding airport. The passenger arrival time is a temporal limiting factor because the passenger arrival time limits the possibilities of outgoing flights. Thus, a modified version of the classical shortest path problem is created. The arcs represent each available flight in the network. Preferably, the cost associated with each arc is calculated during preprocessing. Moreover, the passenger engine 106 can utilize arcs of other airlines in order to allow seeking an optimal solution without such a limitation. The second algorithm initially solves for a solution in order to transport passengers from their origin to their destination in the shortest time with a view to the cost function associated with each possible itinerary. The solutions generated by the second algorithm create columns in an IP problem wherein each column represents an itinerary.

At step 315 of FIG. 3A, the passenger engine 106 solves an IP problem that incorporates the solutions generated at step 310 only. The passenger engine 106 applies a third algorithm to the solutions for the defined subclass of passengers. Preferably, the third algorithm is a Simplex type with branch and bound. By pruning the branches that do not yield better solutions, the best solutions are very efficiently located. In a preferred embodiment, the CPLEX IP-Solver is used, but other IP Solvers can be used as would be known to those of ordinary skill in the pertinent art based upon review of the subject disclosure. It is envisioned that the formulation can be entered fairly directly in to a plurality of different IP solvers together with the generated possible itineraries to achieve a solution. After solving the IP problem, a very good solution exists but as time allows, further processing can further improve the solution and the passenger engine 106 proceeds to step 320. In another embodiment, the passenger engine 106 solves a larger IP problem that incorporates the solutions generated at steps 308 and 310. In this manner, the available seats and opportunities created by rerouting the subclass of passengers are efficiently utilized for the remaining passengers benefit. By solving the larger IP problem for all passengers and stopping, the passenger engine 106 yields a very good solution in a shorter amount of time. Alternatively, the passenger engine 106 may also proceed to step 320 for further processing.

Referring still to step 315 during solving the IP problem, the constraints are checked to prune the solution space. The cost of each solution is calculated to determine if the solution should be pruned. In a preferred embodiment, the objective function in the IP formulation of the passenger rebooking problem is

$$min {\sum }_{ij} ( {c}_{ij} {x}_{ij} ) + {\sum }_{i} {u}_{i} ( {N}_{i} - {\sum }_{j} {x}_{ij} )$$

wherein: an itinerary class (hereinafter “IC”) is an itinerary consisting of a sequence of cabin classes on specific flights; a PaxGroup (hereinafter “PG”) is a group of passengers that have booked the same itinerary and are booked in the same cabin class on each of the flights in the itinerary; xᵢⱼ is the number of passengers from PG i, who are assigned to ICj; cᵢⱼ is the cost of assigning one passenger from PGᵢ to ICⱼ; uᵢ is the cost of leaving one passenger from PGᵢ unhandled; and Nᵢ is the number of passengers in PGᵢ. The decision variable xᵢⱼ is only created for compatible ICs and PGs. That is, xᵢⱼ only be created for ICs and PGs with the same origin-destination pair and when the final arrival of the IC is within a reasonable time window from the final arrival of the PG. The first term in the objective function sums the cost of reassigning the passengers and the second term sums the cost of unhandled passengers.

Still referring to step 315, the passenger engine 106 avoids solutions based upon violation of selected constraints. The passenger engine 106 will not assign more passengers to a cabin than the cabin's capacity and the like. A capacity constraint function is

$${\sum }_{j} {a}_{jk} {x}_{ij} \leq {CAP}_{k} , ∀ k ∈ K$$

wherein CAPₖ is the capacity of cabin k; aⱼₖ is set to one in case ICⱼ makes use of cabin k; and K is the set of all cabins. The passenger engine 106 does not allow assigning more passengers from a PG than actually exist in the PG according to the following PG constraint function

$${\sum }_{j} {x}_{ij} \leq {N}_{i} , ∀ i ∈ G$$

wherein G is the set of all PGs.

Referring again to FIG. 3A, the passenger engine 106 continues processing in order to improve upon the solution. At step 320, the passenger engine 106 excludes the subclass of passengers rescheduled at step 310 and optimized at step 315. The passenger engine assumes that the extra effort to optimally accommodate these passengers has efficiently and appropriately rerouted them. As a result, the size of the transportation problem has been reduced in comparison to that of step 305. For example, in the course of rerouting the subclass, additional vacancies may have been created that may now be utilized to improve upon the solution. The process proceeds to step 325.

At step 325, the passenger engine 106 solves the shrunken transportation problem for the remainder of the passengers. The passenger engine 106 applies an algorithm as above at step 305 of FIG. 3A to complete the processing. It is also envisioned that the passenger engine 106 may repeat all or a portion of the process of FIG. 3A with a subset of the subclass of step 310 in order to further try and improve upon the solution.

Referring now to FIG. 3B, another method of the passenger engine 106 for generating different alternative solutions using a multi-algorithm technique is described in more detail. At step 300′, the passenger engine 106 has the disruption specification and up-to-date schedule data from the memory storage system 114 and the generation of solutions begins. The passenger engine 106 proceeds step 310′.

At step 310′, the passenger engine 106 applies a shortest path algorithm to generate possible routes for each passenger. Each affected passenger could be rerouted along a different itinerary in order to find solutions. In addition, multiple itineraries are generated for each passenger. It is recognized that as the number of affected passengers increases, a very large shortest path problem would be generated. As a result, the computational time could be undesirably long at this step. Similarly, the calculations required at subsequent steps can become very large and time consuming as well. However, for small disruptions, small airlines such as those with a single hub having most flights passing through the hub, and as computational power increases, the process of FIG. 3B is very competitive. At step 315′ of FIG. 3B, based upon the solutions generated at step 310′, the passenger engine 106 solves the whole IP problem as described above and the process is completed.

In another embodiment, the passenger engine 106 employs the entire process of FIG. 3A for large problems versus employing an alternative process for smaller problems. The alternative process may be the process of FIG. 3B, a portion of the process of FIG. 3A, only solving a series of transportation problems, and the like. The operations manager defines large versus small problems as would be known to one of ordinary skill in the art. The methods of FIGS. 3A and 3B can also be employed by the same passenger engine 106 according to a plurality of rules defined by the operations manager. For example, the operations manager could define medium size problems for steps 300-315 of the method of FIG. 3C to solve, employ the method of FIG. 3A to large problems and employ the method of FIG. 3B for small problems.

After the passenger engine 106 completes the solution process, the complete passenger rescheduling solutions are provided to the integration engine and the process of FIG. 2 continues at step 220. Referring again to FIG. 2, at step 220, the integration engine 108 has received the proposed solutions not only from the passenger engine 106 but from any other engines that are working. In a preferred embodiment, the fleet engine 102 and crew engine 104 solve the disruption specification which is modified by the solutions prior to submission to the passenger engine 106 for processing. The complete solutions are presented to the operations manager for evaluation via the user interface 112. The operations manager needs to be able to compare one combination of solutions generated by the engines 102, 104, 106 to another.

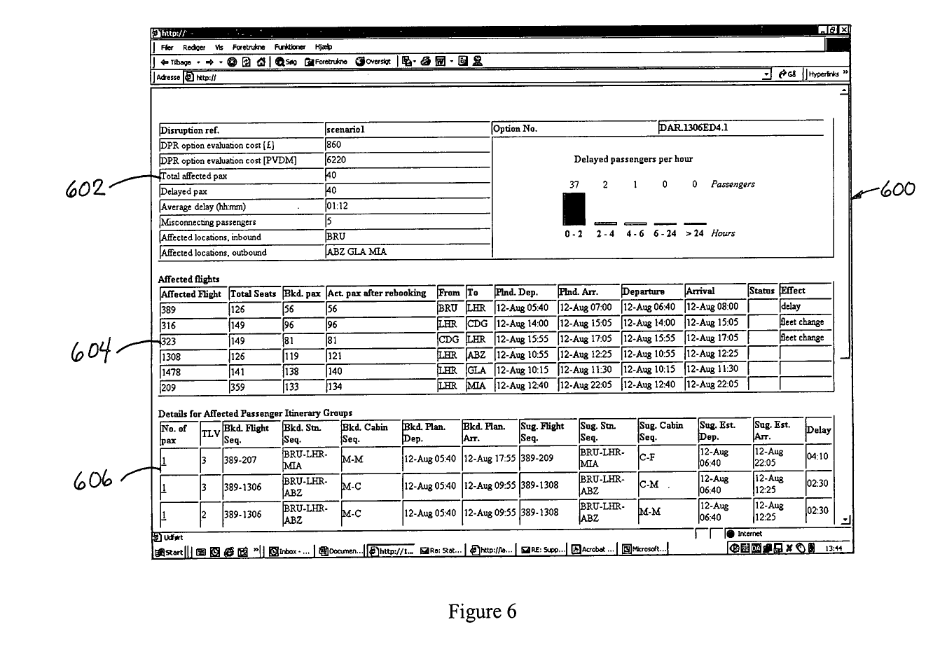

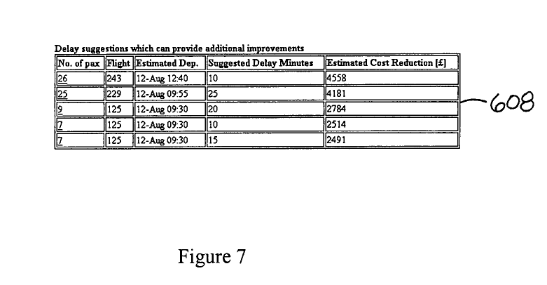

Referring now to FIGS. 6 and 7, the passenger engine 106 provides at least one solution in the form of an HTML document 600. The document 600 includes a summary 602 of the quality of the solution, a list 604 of modified flights, a data section 606 identifying each passengers modified itinerary and a table 608 of suggested improvements. The suggested improvements are added to the disruption specification as recovery options. The integration engine 108 subsequently evaluates the suggested improvements and verifies the legality with the fleet engine 102 and the crew engine 104 so that the user is only presented with feasible recovery options. In effect, the operations manager is provided with a complete rebooking scenario in data section 606 with passenger costs in the summary 602.

In another embodiment, the integration engine 108 provides the solution or solutions generated by the passenger engine 106 to the fleet engine 102 and the crew engine 104 to determine feasibility and legality under the constraints therein as well as additional actual cost and penalty value cost information. For example, the passenger engine 106 can suggest re-timings of flights to the fleet engine 102. The fleet engine 102 can utilize the list 604 to evaluate the solution and provide further information to the operations manager.

The summary 602 aggregates data about the recovery option such as real monetary costs as an evaluation cost and total delay in passenger value delay minutes (“PVDM”) to allow quick evaluation of the solution. The summary also includes details regarding the total number of passengers, average delay and like information as can be appreciated by those of ordinary skill in the pertinent art based upon review of FIG. 6. Preferably, a summary 602 for a plurality of the best solutions are provided to the operations manager for review. The list 604 provides information for each flight involved in the disruption and recovery therefrom. Of particular interest for each flight is the number of added or removed passengers and any modification such as delay or fleet change as compared to the original passenger booking and times.

Still referring to FIGS. 6 and 7, the data section 606 identifies each passenger and provides rebooking instructions by passenger name records (hereinafter “PNR”). The operations manager can track the rerouting of a particular customer of interest to verify an acceptable itinerary is part of the solution. In a preferred embodiment, the data section 606 provides all of the necessary information to rebook each passenger in accordance with the solution. Preferably, interfaces are provided so that the rebookings described in data section 606 can be implemented automatically by the press of a software button.

The table 608 provides the operations manager with suggestions for flight delays that can further reduce the cost of the recovery solution as is often the case because small delays will typically not cause missed connections. The operations manager can prompt the passenger engine 106 to continue optimizing the solutions. The passenger engine 106 can find passenger groups with missed connections and delay the outbound flight sufficiently for the passenger to catch the flight. This creates a new IP-problem to be resolved and a reduced transportation problem. If a lower cost option arises, the original option is discarded in favor of the new solution. The passenger engine 106 may also simply present to the operations manager all of the non-discarded suggestions generated.

Referring again to FIG. 2, step 220, the operations manager may also request each engine 102, 104, 106 to fully evaluate the schedule of one or more solutions for any rule violations under one or more of the other engines, i.e., send an alert generation request. The engine 102, 104, 106 will evaluate the selected solutions for violations and generate an alert for each violation of the rules. The operations manager can further utilize the alerts to select and implement a solution.

In a preferred embodiment, the operations manager selects the penalty value costs based upon the policies and objectives of the airline so that the solutions generated by the engines 102, 104, 106 would reflect those policies and objectives. The specified costs would include penalty values in terms of dollars/minute of delay, upgrades, downgrades and the like. Monetary costs would include meal vouchers, lodging vouchers, and the like. For an example of setting a specified cost to enact a policy, unaccompanied minors and gold card passengers can have higher values than other travelers on the same itinerary as well as denying passengers due to overbooking, i.e., offloading. Thus, the policy of avoiding offloading and delaying unaccompanied minors and gold card members is enacted by such actions carrying a high penalty value. The high penalty values will make solutions with those actions compare poorly with other solutions and, thus, alternatives will be generated.

In another alternative embodiment, the integration engine 108 skips over steps 220 and 225 to step 230 and automatically implements the overall lowest cost solution by updating the schedule data 114 and utilizing the network to undertake remaining tasks such as notifying maintenance personnel, crews and passengers of schedule changes. It is envisioned that the notification may be made by updating Internet Web pages, automated telephonic communications by text messaging and otherwise, displays at the airport, electronic mail and other means of communication now known and later developed.

At step 225, the operations manager can select a solution. If the operations manager deems a solution acceptable for implementation, the process proceeds to step 230. If the operations manager does not find any of the solutions acceptable, the process can proceed to step 215 for generating additional solutions by utilization of another method or further application of the same methods as described above. At step 230, if a solution is acceptable, the solution is implemented. The airline reenters a monitoring operations mode at step 200 until another alert comes and the cycle continues.

In another embodiment, the system and methods shown herein are useful as a simulation tool. The operations manager may modify the rules and/or penalty value costs to reflect different policies and input hypothetical disruptions. Review of the resulting solutions would allow quantitative assessment of the overall cost of certain policies during disruptions. Based upon these assessments, effective policies can be identified and implemented. For example, the operations manager can investigate different trade-offs such as between a quick recovery and a low operational cost, or between minimum changes and a stable operation.

While the invention has been described with respect to preferred embodiments, those skilled in the art will readily appreciate that various changes and/or modifications can be made to the invention without departing from the spirit or scope of the invention as defined by the appended claims.

1. A method for generating a solution to a problem having objects scheduled originally in itineraries, each original itinerary having at least an origin and a destination, the method comprising the steps of:
receiving a disruption specification based upon an event, the disruption specification including data identifying the objects to be rescheduled;
receiving a request for rescheduling of the objects from a user;
grouping the objects to be rescheduled into subproblems, wherein each subproblem is defined by each object therein having the same original origin and destination;
applying a first algorithm to each subproblem without allowing varying the origin and destination of the objects in the subproblem for simplification and, in turn, quickly reaching initial solutions;
identifying a subclass of objects that are unsuitably rescheduled in the initial solutions; and
applying a second algorithm for rescheduling the subclass that allows varying the original itinerary to generate rescheduling solutions for the subclass.

2. A method as recited in claim 1, further comprising the step of applying a third algorithm to an IP problem based upon all of the objects.

3. A method as recited in claim 2, wherein the third algorithm is an IP algorithm with a branch and bound technique.

4. A method as recited in claim 2, further comprising the steps of excluding the subclass of objects from the objects that need to be rescheduled in the disruption specification and applying a fourth algorithm to the remaining objects in the reduced disruption specification to determine rescheduling solutions for the remaining objects.

5. A method according to claim 4, wherein the first and fourth algorithms are transportation simplex algorithms.

6. A method as recited in claim 1, wherein the subclass of objects to be rerouted are identified based upon a suitably of rescheduling criteria.

7. A method as recited in claim 6, wherein identifying the subclass includes determining a cost for each rescheduled object and comparing the cost to a threshold.

8. A method as recited in claim 1, wherein the objects are passengers traveling one or more legs between the origin and the destination.

9. A method as recited in claim 1, wherein the rescheduling solutions include upgrading, downgrading, delaying, and offloading the objects.

10. A method according to claim 1, wherein the second algorithm is selected from the group consisting of the Dijkstra algorithm and a K-shortest path algorithm.

11. A method for generating solutions to problems having objects scheduled in itineraries, the method comprising the steps of:
receiving a disruption specification based upon an event, the disruption specification including data identifying at least one object to be rerouted;
applying a shortest path algorithm to generate a plurality of possible solutions for rerouting the at least one object;
forming an IP problem based upon the plurality of possible solutions; and
applying an IP algorithm to the IP problem for generating a practical solution for rerouting the at least one object.

12. A method as recited in claim 11, wherein the event is selected from the group consisting of an airplane breakdown, a hub closing, flight cancellation and a weather storm.

13. A method as recited in claim 11, wherein the IP algorithm utilizes a branch and bound technique.

14. A method for generating solutions to problems having objects scheduled in itineraries, the method comprising the steps of:
receiving a disruption specification based upon an event, the disruption specification including data identifying objects to be rerouted;
grouping the objects to be rescheduled into subproblems, wherein each subproblem is defined by each object therein having the same original origin and destination; and
applying an algorithm for generating solutions to each subproblem.

15. A method as recited in claim 14, wherein the algorithm is a transportation algorithm.

16. A method as recited in claim 14, further comprising the steps of:
identifying a subclass of objects that are unsuitably rescheduled in the initial solutions;
applying a shortest path algorithm for rescheduling the subclass to generate additional possible rescheduling solutions for the each object in the subclass.

17. A method as recited in claim 16, further comprising the steps of:
applying an IP algorithm based upon the additional possible rescheduling solutions to generate a practical solution for rerouting the objects.

18. A method as recited in claim 17, further comprising the steps of:
excluding the identified subclass to reduce the disruption specification; and
solving the reduced specification by applying a transportation algorithm.

19. A method as recited in claim 18, further comprising the step of varying the origin and destination of the objects only at the step of solving the reduced specification.

20. A method as recited in claim 18, further comprising the step of grouping the objects by segment prior to solving the reduced disruption specification

21. A method for generating solutions to problems having objects scheduled in itineraries, the method comprising the steps of:
receiving a disruption specification based upon an event, the disruption specification including data identifying objects to be rerouted;
grouping the objects to be rescheduled into subproblems, wherein each subproblem is defined by each object therein having the same original origin and destination;
applying a transportation algorithm for generating solutions to each subproblem;
identifying a subclass of objects that are unsuitably rescheduled in the initial solutions; and
applying a shortest path algorithm for rescheduling the subclass to generate multiple possible rescheduling solutions for the each object in the subclass; and
applying an IP algorithm based upon the transportation algorithm and shortest path algorithm solutions to generate a practical solution for rerouting the objects.
excluding the subclass of objects from the objects that need to be rescheduled in the disruption specification; and
applying a fourth algorithm to the remaining objects in the reduced disruption specification to determine rescheduling solutions for the remaining objects.

22. A method according to claim 21, wherein during applying the shortest path algorithm, a temporal limitation of arrival time is included in the disruption specification.

23. A method according to claim 21, wherein the forth algorithm is the same as the transportation algorithm.

24. A method as recited in claim 21, wherein the objects are passengers traveling on one of a group consisting of an airplane, a train and a bus.

25. A method as recited in claim 21, wherein the IP algorithm uses a branch and bound technique with a cost function.

26. A method as recited in claim 21, wherein the cost function is
$$min {\sum }_{ij} ( {c}_{ij} {x}_{ij} ) + {\sum }_{i} {u}_{i} ( {N}_{i} - {\sum }_{j} {x}_{ij} )$$
wherein: an itinerary class (hereinafter “IC”) is an itinerary consisting of a sequence of cabin classes on specific flights; a PaxGroup (hereinafter “PG”) is a group of passengers that have booked the same itinerary and are booked in the same cabin class on each of the flights in the itinerary; xᵢⱼ is the number of passengers from PG i, who are assigned to ICj; cᵢⱼ is the cost of assigning one passenger from PGᵢ to ICⱼ; uᵢ is the cost of leaving one passenger from PGᵢ unhandled; and Nᵢ is the number of passengers in PGᵢ.

27. An engine for generating solutions to a rescheduling disruption of objects comprising:
applying a first process for large problems; and
applying a second process for small problems, wherein the small and large problems are defined by a user.

28. A method according to claim 27, wherein the first process includes the steps of:
receiving a disruption specification based upon an event, the disruption specification including data identifying objects to be rerouted;
grouping the objects to be rescheduled into subproblems, wherein each subproblem is defined by each object therein having the same original origin and destination;
applying a transportation algorithm for generating solutions to each subproblem;
identifying a subclass of objects that are unsuitably rescheduled in the initial solutions; and
applying a shortest path algorithm for rescheduling the subclass to generate additional possible rescheduling solutions for the each object in the subclass.

29. A method according to claim 27, wherein the first process further includes the step of solving an IP problem for all passengers.

30. A method according to claim 27, wherein the second process includes the steps of:
receiving a disruption specification based upon an event, the disruption specification including data identifying at least one object to be rerouted;
applying a shortest path algorithm to generate a plurality of LP solutions for rerouting the at least one object; and
applying an IP algorithm based upon the plurality of LP solutions to generate a practical solution for rerouting the at least one object.

31. A method according to claim 27, wherein the second process includes the steps of:
receiving a disruption specification based upon an event, the disruption specification including data identifying objects to be rerouted;
grouping the objects to be rescheduled into subproblems, wherein each subproblem is defined by each object therein having the same original origin and destination; and
applying a transportation algorithm for generating solutions to each subproblem.
